(19) United States
(12) Patent Application Publication
(10) Pub. No.: US 2002/0062483 A1
(43) Pub. Date: May 23, 2002

(54) Two-way communication system

(76) Inventors: Masayuki Ishizaki, Kawasaki (JP); Akira Miyasaka, Kawasaki (JP); Masao Ota, Kawasaki (JP)

Correspondence Address: ROSENMAN & COLIN LLP, 575 MADISON AVENUE, NEW YORK, NY, 10022-2585, US

(21) Appl. No.: 09/809,384

(22) Filed: Mar. 15, 2001

(30) Foreign Application Priority Data
Nov. 20, 2000 (JP) 2000-353253

(51) Int. Cl. H04N 7/173

(52) U.S. Cl. 725/105; 725/111; 725/115

(57) ABSTRACT

The two-way communication system which provides program information distributed in a predetermined broadcasting system from a program information provider for a CATV subscriber through a CATV network, processes return information returned from the CATV subscriber, and transmits the processed information to the program information provider is disclosed.

### BACKGROUND OF THE INVENTION

The present invention relates to a two-way communication system for providing various two-way broadcasting services for subscribers through a CATV (community antenna television) network.

Conventionally, two-way broadcasting services have been realized using a satellite broadcasting system and a terrestrial TV broadcasting system.

FIG. 24 shows the outline of the configuration of the conventional two-way communication system using the satellite broadcasting system and the terrestrial TV broadcasting system. As shown in FIG. 24, a server operation company and an information/service provider distribute picture information, etc. for each subscriber through a down line using the satellite broadcasting system and the terrestrial TV broadcasting system. When a distribution system referred to as a pay-per-view (PPV) for distribution of information in a broadcasting program unit is adopted, each subscriber can apply to an information/service provider, etc. for a desired program through an up line using a telephone line each time when a favorite program is distributed. Such a distribution system is a type of two-way broadcasting service, and conventionally has been widely used in the CATV system and the satellite broadcasting system.

Thus, although the conventional two-way broadcasting service using the satellite broadcasting system, etc. has been realized mainly by the services of distributing pictures in the pay-per-view system, etc., a service using a broadcasting system referred to as a data broadcasting system is being realized with an increasing use of recent digitized broadcasting media. In this data broadcasting system, it is planned to distribute multimedia contents such as character information, static images, animation, programs, etc. to a common television receiver and a personal computer using broadcasting waves. Various practical contents of the broadcasting can be weather forecast information, market information, travel information, shopping information, etc. For example, when the contents of broadcasting are to be displayed on a television, a user operates a cursor key, a numeric key, etc. provided for a remote controller, and can retrieve target information.

FIG. 25 shows the outline of a data broadcasting system using a satellite broadcasting system. As shown in FIG. 25, a user is provided in his or her home a receiver referred to as an integrated decoder (IRD). An antenna mounted on the roof, the verandah, etc. is connected to the receiver. Using the antenna, a broadcasting wave at a predetermined frequency is received to perform a demodulating process, a descrambling process, etc. In addition, a television set (TV) is connected to the receiver, and the user operates a remote controller, and selects only a desired program from among various broadcast programs received by the receiver.

The return information to be returned from a user to a data broadcasting company is transmitted normally through a public line. For example, most typically, the return information about selection indication such as the contents of shopping items, the market information or the travel information, etc. to be displayed, is transmitted to a data broadcasting company through a telephone line.

In the data broadcasting through the above mentioned satellite broadcasting or similar services using the terrestrial TV broadcasting, when the personal information about each user is transmitted from a user to a data broadcasting company using a telephone line, etc. as an up line, an inputting operation is complicated, and it takes a long time to input necessary data.

For example, assume that a user operates an accessory remote controller of the receiver, selects a ‘shopping service’ from menu of data broadcasting, selects a desired item from among the displayed items, and then place an order. The user who is receiving such a service has to operate a remote controller to input the item number, the name of the user, the address of the user, the number of his or her credit card, etc. on an order screen after receiving and displaying the input screen (order screen) on which an order can be placed. It is necessary for a user who wants to receive such a service to register the address, the name, etc. of the user to a data broadcasting company beforehand. Especially, the user has to register them for each data broadcasting company when the user requests to use services from a plurality of data broadcasting companies. Furthermore, the registering process is complicated. In addition, since the contents of the order screens are different among the plurality of data broadcasting companies, it is much complicated to input a number of items depending on each of the different order screens.

### SUMMARY OF THE INVENTION

The present invention has been developed to solve the above mentioned problems, and aims at providing a two-way communication system capable of reducing the operation and the time required in a data-inputting operation.

The two-way communication system according to the present invention provides the program information distributed from a program information provider to a CATV subscriber, receives the return information returned from the CATV subscriber through return information reception unit in the CATV center when the return information is returned from the CATV subscriber to the program information provider, and transmits to a program information provider the return information processed by return information process unit. Since the information can be amended depending on the contents requested by the program information provider by processing the return information in the CATV center, the contents of the return information generated by the CATV subscriber himself or herself can be simplified, thereby reducing the operation and the time required in inputting the return information.

It is desirable that the process of the return information performed by the above mentioned return information process unit is performed by adding supplementary information to the return information, or by replacing the return information with the supplementary information. By generating the supplementary information in the CATV center, the operation performed in inputting the supplementary information by a CATV subscriber can be omitted.

In addition, it is desirable that the CATV center includes a database storing the contract information about a CATV subscriber when the above mentioned CATV network is used, and the return information process unit generates the supplementary information according to the personal information contained in the contract information about the CATV subscriber stored in the database. The personal information contained in the contract information includes the data about names, addresses, etc. Since they are normally described by kanji, they require a laborious data-inputting operation. Therefore, by removing the necessity of inputting them, the load of the CATV subscriber can be considerably reduced.

Furthermore, it is desirable that the above mentioned return information process unit converts the return information input by the CATV subscriber in a simple format into the supplementary information in a detailed format. Although the program information provider requests the information in the detailed format, the inputting operation by the CATV user can be performed in the simple format. Therefore, the CATV subscriber can reduce the laborious data-inputting operation. In addition, the program information provider can obtain information in a desired format.

Additionally, it is desirable that the process performed by the return information process unit on the return information is an aggregating process on the return information returned from the CATV subscriber. Since the program information provider can receive the result of the aggregating process, the load of the process can be reduced than in performing the aggregating process all by the program information provider.

It is further desirable that the above mentioned return information process unit transmits the return information itself to the program information provider when the information is required to be returned in a short time. In case when the return information returned from the CATV subscriber is required to reflect immediately in a program being broadcast, it is necessary to transmit the return information to the program information provider without delay. It can be realized that the shortest delay time by transmitting the return information itself to the program information provider without processing the information. In this case, it is desirable that the result of processing the return information is transmitted after the return information itself has been transmitted. Thus, the program information provider can obtain both information to be handled in a real time process and information with an added value.

In the case where the above mentioned program information provider is a public organization, it is desirable that the information of applying for a service provided by the public organization is return information. Thus, it is possible to use the CATV center as a branch office of the public organization.

Furthermore, it is desirable that a public telephone line is used as an up line for transmission of the return information to the CATV center from return information generation/transmission unit. Using a widely adopted public telephone line as an up line, an up line can be reserved with the smallest equipment investment. Otherwise, it is desirable that the transmission line of a CATV network is used as an up line through a cable modem. Since the return information can be transmitted through a normally connected transmission line, the delay in the process of transmitting the return information can be reduced.

In addition, it is desirable that an area having a transmission frequency at or higher than 770 MHz is used as a band of a signal containing the above mentioned return information. Normally, the transmission band of a CATV uses an area having a frequency at or lower than 55 MHz as the frequency band of an up line, but this frequency band contains much noise of city type. Therefore, by replacing the area having a frequency at or lower than 55 MHz with an area having a frequency at or higher than 770 MHz, efficient transmission/reception of return information can be realized without an influence of the noise of city type.

When program information reception unit for receiving program information, a television set for displaying the contents of the received program information, and a remote controller having a plurality of operation keys are provided in the home of a CATV subscriber, it is desirable that the CATV subscriber inputs the return information by operating the plurality of operation keys provided on the remote controller with an input screen in a simple format displayed on the TV. Since the CATV subscriber can input the return information only by data-inputting necessary items on the input screen in the simple format while operating the remote controller, the laborious inputting operations can be considerably reduced.

In addition, it is desirable to disperse the reception timing of return information in the return information reception unit by providing transmission timing designation unit for designating the transmission timing of return information corresponding to each of the plurality of CATV subscribers. Otherwise, it is desirable to disperse the reception timing of return information in the return information reception unit by providing path switch unit for selectively activating a plurality of paths through which return information corresponding to each of the plurality of CATV subscribers. By dispersing the reception timing of the return information, a transmission line can be efficiently used.

Furthermore, it is desirable that an additional rate is collected from the CATV subscriber for receiving a process service or a program information provider with a predetermined additional rate set corresponding to the service of processing return information by the above mentioned return information process unit. The CATV company can collect an additional rate corresponding to providing an added value obtained by performing a process, thereby extending the opportunity of new business.

It is further desirable that the above mentioned return information generation/transmission unit has memory storing the information about a plurality of simple formats any of which can be selected, and selectively displays the contents of the input screen in a plurality of simple formats in response to the instruction from the CATV subscriber. Since the contents of the simple format to be used can be selected while confirming the contents, the operability by the CATV subscriber can be improved.

In addition, it is desirable that the above mentioned personal information contains the information about the configuration of the family of a CATV subscriber, the return information generation/transmission unit generates the return information containing the first identification information specifying the CATV subscriber itself and the second identification information specifying the configuration of the family of the CATV subscriber, and the return information process unit generates the supplementary information according to the first and the second identification information contained in the return information. Normally, the representative of a family applies for a CATV service, but another member of the family can be a user who is the source of return information. Therefore, the entire family can use the services according to the present invention by setting the CATV subscriber (applicant) associated with the identification information about each of the members of the family.

In addition, when the above mentioned detailed format is set by a program information provider, it is desirable that the CATV center is provided with a detailed format collection unit for automatically fetching the detailed format containing new contents set by a program information provider. Since the latest detailed format can be obtained in the CATV center, the information about the optimum format can be constantly provided for the program information provider.

### BRIEF DESCRIPTION OF THE DRAWINGS

FIG. 1 is a diagram showing the outline of the configuration of the two-way communication system according to an embodiment of the present invention;

FIG. 2 is a diagram showing a satellite frequency band when a BS line is used as a down line;

FIG. 3 is a diagram showing the frequency band of a CATV network;

FIG. 4 is a diagram showing the detailed configuration of a trans-modulation device;

FIG. 5 is a diagram showing the connection of the transmission line in the CATV network according to an embodiment of the present invention;

FIG. 6 is a diagram showing the detailed configuration of a set top box;

FIG. 7 is a diagram showing a practical example of a detailed format;

FIG. 8 is a diagram showing a practical example of a detailed format;

FIG. 9 is a diagram showing a practical example of a detailed format;

FIG. 10 is a diagram showing a practical example of a simple format;

FIG. 11 is a diagram showing a practical example of a simple format;

FIG. 12 is a diagram showing a practical example of a simple format;

FIG. 13 is a flowchart of the procedure of the operations of the set top box when a subscriber inputs return information;

FIG. 14 is a flowchart of the procedure of the operations of the subscriber management server when return information is received;

FIG. 15 is a flowchart of the procedure of the operations of the subscriber management server when reception timing is dispersed;

FIG. 16 is a flowchart of the procedure of the operations of a set top box when reception timing is dispersed;

FIG. 17 shows an example of a variation of the connection of the transmission line in a CATV network;

FIG. 18 is a flowchart of the procedure of the operations of the subscriber management server when an up path is selected to disperse reception timing;

FIG. 19 is a flowchart of the procedure of the operations of the subscriber management server for transmitting received return information within a short time;

FIG. 20 is a diagram showing the configuration of the two-way communication system when return information is transmitted using a public telephone line as an up line;

FIG. 21 is a diagram showing the detailed configuration of a set top box containing a telephone modem;

FIG. 22 is a flowchart of the procedure of the operations of a subscriber management server for automatically collecting a detailed format;

FIG. 23 is a diagram showing the configuration of a re-multiplex device;

FIG. 24 is a diagram showing the outline of the configuration of the conventional two-way communication system; and

FIG. 25 is a diagram showing the outline of the system of the data broadcasting using satellite broadcasting.

### DESCRIPTION OF THE PREFERRED EMBODIMENT

The two-way communication system according to the present invention is described below by referring to the attached drawings.

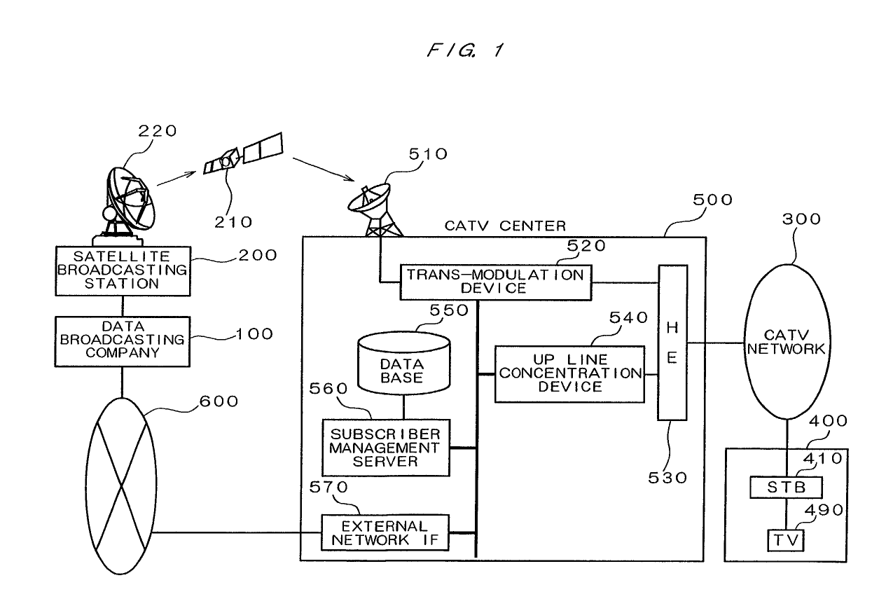

FIG. 1 shows the outline of the configuration of the two-way communication system according to an embodiment of the present invention.

As shown in FIG. 1, the two-way communication system according to an embodiment of the present invention comprises: a satellite broadcasting station 200 and a satellite 210 for distributing program information provided by a data broadcasting company 100 through a satellite line; a CATV center 500 for receiving and then transmitting the program information distributed through the satellite line to each subscriber home 400 through a CATV network 300; and a public network 600 used for transmission of the return information such as a reply, an order, etc. received from each subscriber home 400 to the data broadcasting company 100 after processing the information in the CATV center 500. The subscriber home 400 comprises a set top box (STB) 410 for transmitting and receiving various information to and from the CATV network 300, and a TV 490 connected to the set top box 410.

When the program information is transmitted from the data broadcasting company 100 to each CATV subscriber (hereinafter referred to simply as a subscriber), a satellite line and a down line through the CATV network 300 are used. That is, various program information provided from the data broadcasting company 100 is modulated in a modulation system applicable to the satellite broadcasting by the satellite broadcasting station 200, and then transmitted as a broadcasting wave at a predetermined frequency from an antenna 220. The broadcasting wave is received by an antenna 510 provided in the CATV center 500 via a satellite 210. Thus, when the program information is received through the satellite line, the CATV center 500 performs a modulating process applicable to the CATV network 300, and distributes the received program information to each subscriber home 400 through the CATV network 300.

In each subscriber home 400, the program information transmitted from the CATV center 500 through the CATV network 300 is received by the set top box 410, the contents of the program information are displayed on the TV 490 attached to the set top box 410, and the corresponding voice is output from the built-in speaker of the TV 490.

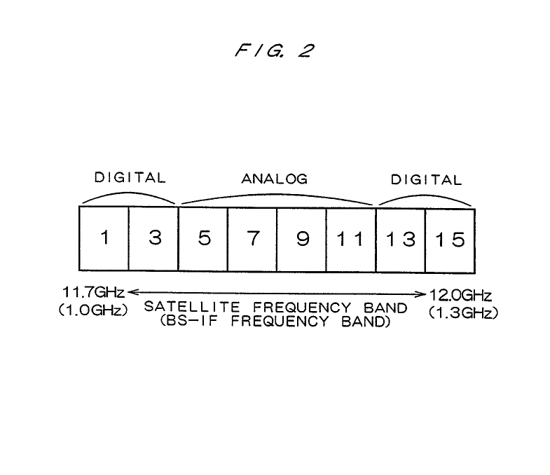

FIG. 2 shows the satellite frequency band when a BS line is used as a down line. As shown in FIG. 2, the frequency band of the BS at present is in the range of 300 MHz from 11.7 GHz to 12.0 GHz. In the frequency band, eight odd-number channels from channel 1 to channel 15. In these eight odd-number channels, channels 1, 3, 13, and 15 are used in the BS digital system.

By the way, in the BS digital system, a torellis-coded 8-phase PSK is used as a modulation system, and the transmission capacity of approximately 52 Mbps at maximum at 99% energy band width of 34.5 MHz is reserved for each channel.

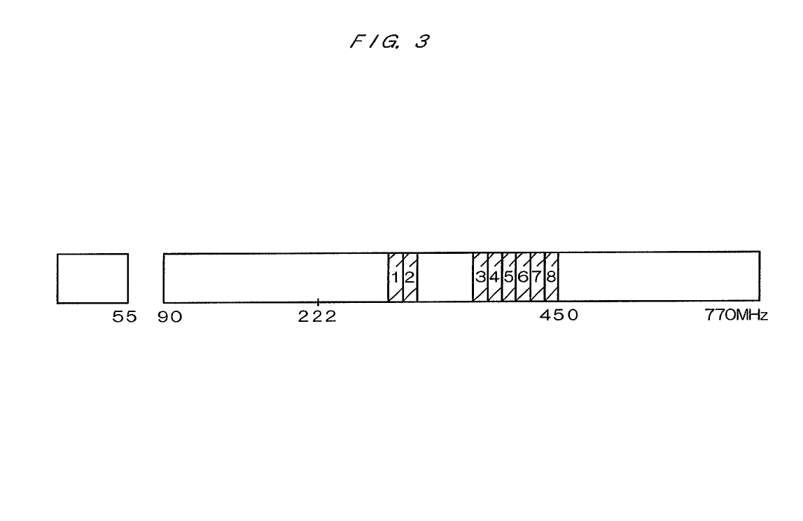

FIG. 3 shows the frequency band of a CATV network. In the frequency band shown in FIG. 3, the frequency band at or lower than 55 MHz is used for an up line, and the frequency band from 90 to 770 MHz is used for a down line. However, since a certain range in the frequency band from 90 to 770 MHz corresponding to the down line is practically being used, it is necessary to assign an available frequency excluding the range. In addition, since the frequency band at or lower than 55 MHz has already been reserved for an up line, the return information is transmitted from the subscriber home 400 to the CATV center 500 using the frequency band. However, it is desired that the return information can be transmitted using the frequency band at or higher than 770 MHz. Normally, since noise of city type is contained in the frequency band at or lower than 55 MHz, the return information can be efficiently transmitted and received by using the frequency band at or higher than 770 MHz in which such noise can hardly be contained.

As described above, the transmission capacity of one channel when a BS digital system is adopted is 52 Mbps. However, in the CATV network 300 in which 64 QAM (quadrature amplitude modulation) is adopted as a modulation system, information for the transmission capacity up to 29 Mbps can be transmitted using one channel. Therefore, when the broadcasting program for one channel in the BS digital system is retransmitted from the CATV center 500 to each subscriber home 400 without changing the contents, it is necessary to assign two channels of the CATV network 300. According to this embodiment, it is assumed that eight channels are used for eight hatched areas shown in FIG. 3 corresponding to channels 1, 3, 13, and 15 contained in the satellite frequency band.

As shown in FIG. 1, the CATV center 500 contains a trans-modulation device 520, a head end (HE) 530, an up line concentration device 540, a database 550, a subscriber management server 560, and an external network interface (IF) 570.

The trans-modulation device 520 retransmits the program information received through a satellite line to each subscriber home 400 without changing the contents.

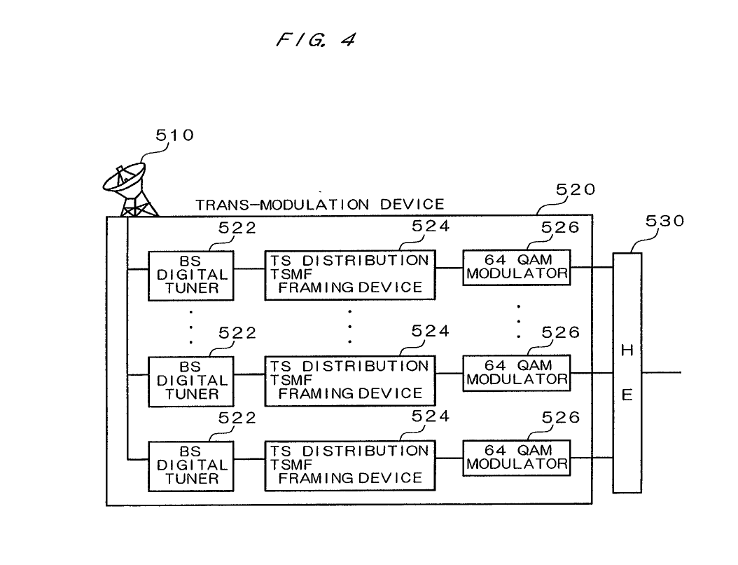

FIG. 4 shows the detailed configuration of the trans-modulation device 520. As shown in FIG. 4, the trans-modulation device 520 comprises plural sets of a BS digital tuner 522, a TS (transport stream) distribution TSMF (TS multiplexing frame) framing device 524, and a 64 QAM modulator 526.

The BS digital tuner 522 demodulates the program information of the satellite broadcasting received by the antenna 510. The TS distribution TSMF framing device 524 distributes the TS and performs a frame multiplexing process to associate the program information for one channel of a satellite line with two channels of the CATV network 300. The 64 QAM modulator 526 performs the 64 QAM modulating process on the program information output from the TS distribution TSMF framing device 524.

The head end 530 provided in the CATV center 500 terminates the transmission line of the CATV network 300, transmits the program information of each channel output from the trans-modulation device 520 to the transmission line for a down line, and receives the return information transmitted from each subscriber home 400 through the transmission line for an up line.

FIG. 5 shows the connection of the transmission line in the CATV network 300 according to an embodiment of the present invention. As shown in FIG. 5, in the CATV network 300 according to this embodiment, a transmission line in the hybrid system in which an optical fiber cable 302, a coaxial cable 304, etc. coexist is used. An optical-to-electrical (O/E) converter 310 converts an optical signal input from the optical fiber cable 302 into an electrical signal, and transmits the resultant signal to the coaxial cable 304. The coaxial cable 304 is connected to a branch device 320, and the electrical signal transmitted through the coaxial cable 304 is branched by the branch device 320, and transmitted to each subscriber home 400 through two or more coaxial cables 306.

The actual CATV network 300 comprises, in addition to the above mentioned configuration, an amplifier for amplifying an electrical signal attenuated by transmission through the coaxial cables 304 and 306, a lead terminal (tap off), etc. as a lead distributor to which a lead connected to each subscriber home 400 is connected. In the above mentioned example, a transmission line in the hybrid system is described, but the transmission line can be designed only using a coaxial cable. In addition, a down line when the program information is distributed from the CATV center 500 to each subscriber home 400 is described above. However, as shown in FIG. 3, since different frequency bands are used between a down line and an up line, the up line is provided using the same transmission line, and the return information is transmitted to the up line using a cable modem (described later) from the subscriber home 400.

The up line concentration device 540 provided in the CATV center 500 receives the return information transmitted from the subscriber home 400 through the up line of the CATV network 300. As described above, according to this embodiment, since the transmission line of the CATV network 300 is used as an up line, the return information transmitted from the subscriber home 400 through the up line is input to the up line concentration device 540 through the head end 530.

The database 550 stores the contract information about each subscriber, the data in the simple format used in transmitting the return information from each subscriber to the CATV center 500, and the data in the detailed format used in transmitting a result of the return information processed in the CATV center 500 to the data broadcasting company 100. For example, the contract information about each subscriber contains personal information such as the name, sex, address, family configuration, number of credit card, personal history, etc. of each subscriber. In addition, each subscriber and his or her family members are associated with code data as the identification information for identifying each member, and each user inputs the assigned code data instead of inputting the name or sex of the user himself or herself of any of the family when the return information is to be input in the simple format. Practical examples of the simple format and the detailed format are described later.

The subscriber management server 560 assigns an added value by performing a predetermined process on the return information transmitted from each subscriber. For providing a service of assigning an added value, the CATV company managing the CATV center 500 collects a predetermined rate from each subscriber and the data broadcasting company 100. The merits for each subscriber and the data broadcasting company 100 when they use the services are described later.

The contents of the process performed on the return information by the subscriber management server 560 includes, for example, the case in which supplementary information is added to return information, and return information is replaced with supplementary information, the case in which an aggregating process is performed using the return information transmitted from a plurality of subscribers, etc.

The external network interface (IF) 570 transmits and receives data between the CATV center 500 and the data broadcasting company 100, and controls the procedure of transmitting and receiving data to and from the public network 600. The public network 600 can be a public telephone network, a packet exchange network, etc. According to this embodiment, the CATV center 500 is connected to the data broadcasting company 100 through the public network 600, but any connection can be accepted only if data can be transmitted and received between them. For example, they can be connected through a dedicated line or a private network.

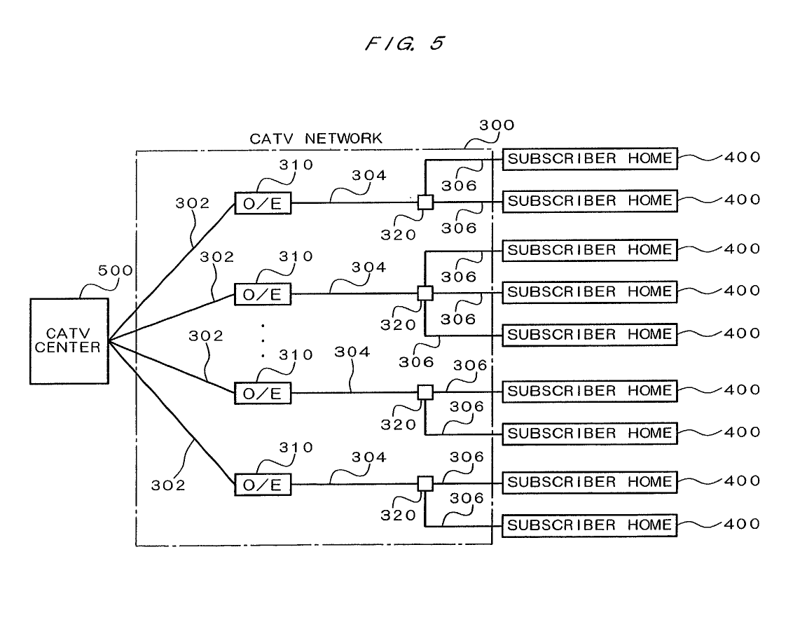

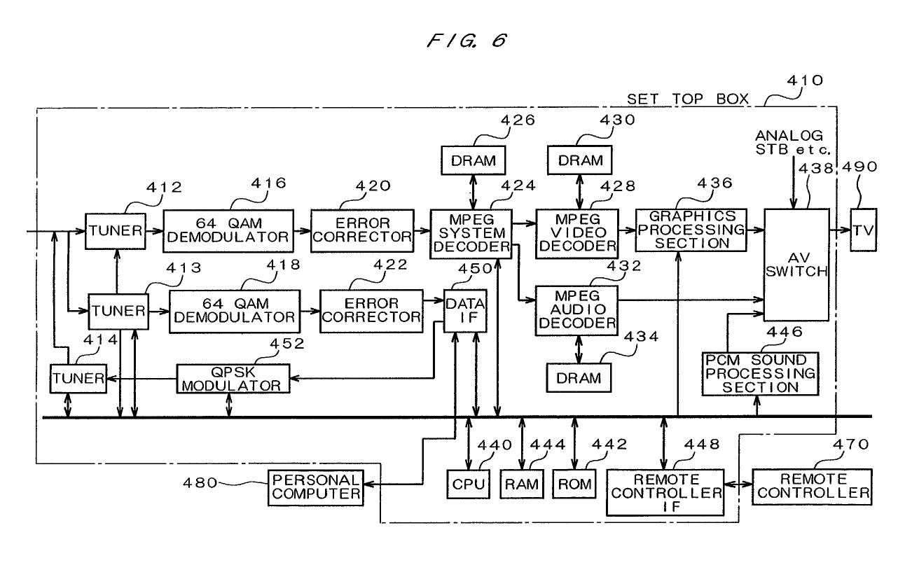

FIG. 6 shows the detailed configuration of the set top box 410 provided in each subscriber home 400.

As shown in FIG. 6, the set top box 410 comprises three tuners 412, 413, and 414, two 64 QAM demodulators 416 and 418, two error correctors 420 and 422, an MPEG system decoder 424, DRAM 426, 430, and 434, an MPEG video decoder 428, an MPEG audio decoder 432, a graphics processing section 436, an AV switch 438, a CPU 440, ROM 442, RAM 444, a PCM sound processing section 446, a remote controller interface (IF) 448, a data interface (IF) 450, and a QPSK modulator 452.

The tuner 412 extracts only the frequency component corresponding to a desired channel from a signal input through the transmission line (coaxial cable) of the CATV network 300. The 64 QAM demodulator 416 performs a demodulating process on a signal modulated in the 64 QAM system and output from the tuner 412. The error corrector 420 performs an error correcting process on the data demodulated by the 64 QAM demodulator 416. The MPEG system decoder 424 separates a video stream in the MPEG system from an audio stream using the DRAM 426 as a work area.

The MPEG video decoder 428 demodulates the video stream data encoded in the MPEG system using the DRAM 430 as a work area. The MPEG audio decoder 432 demodulates the audio stream data encoded in the MPEG system using the DRAM 434 as a work area, and outputs an audio signal.

The graphics processing section 436 generates a necessary picture signal for display on the TV 490 based on the video data obtained in the demodulating process performed by the MPEG video decoder 428. In addition, the graphics processing section 436 generates a necessary picture signal for display of the image information generated by the CPU 440 on the TV 490.

The AV switch 438 selects the picture signal and the audio signal to be output to the TV 490. For example, assuming that a picture signal is input also from the analog set top box (not shown in the attached drawings) in addition to the picture signal output from the graphics processing section 436, the AV switch 438 selects one of these two types of picture signals, and outputs the selected signal to the TV 490. Furthermore, in addition to the audio signal output from the MPEG audio decoder 432, an audio signal is also input from the PCM sound processing section 446, and the AV switch 438 selects one of these two types audio signals, and outputs the selected signal to the TV 490.

The CPU 440 controls the entire set top box 410. The CPU 440 executes a program stored in the ROM 442, uses the RAM 444 as a work area, thereby controlling the operation of inputting return information by operating a remote controller 470, the operation of inputting and outputting data to and from a personal computer 480 connected externally. The remote controller interface 448 controls the operation of inputting and outputting a signal transmitted and received to and from the remote controller 470. For example, an infrared signal transmitted from the remote controller 470 is received by the remote controller interface 448.

The tuner 413 extracts a desired frequency component from a signal input through the transmission line of the CATV network 300. The tuner 412 is used to receive program data, but the tuner 413 is used to receive various data fetched mainly by the personal computer 480. The 64 QAM demodulator 418 demodulates a signal output from the tuner 414 which is modulated in the 64 QAM system. The error corrector 422 corrects an error in the data demodulated by the 64 QAM demodulator 418.

The data interface 450 is used to input and output data between the CPU 440, the personal computer 480, the error corrector 422, and the QPSK modulator 452. For example, the data input from the error corrector 422 is transmitted to the CPU 440 and the personal computer 480 through the data interface 450. In addition, the data input from the CPU 440 and the personal computer 480 is transmitted to the QPSK modulator 452 through the data interface 450.

The QPSK modulator 452 performs a QPSK modulating process on the data input from the data interface 450. The tuner 414 superposes a signal obtained in the QPSK modulating process on the carrier at a predetermined frequency, and transmits it to the transmission line (up line) of the CATV network 300. The tuners 413 and 414, the 64 QAM demodulator 418, the error corrector 422, the data interface 450 , and the QPSK modulator 452 configure a cable modem.

The above mentioned head end 530 and the up line concentration device 540 correspond to the return information reception unit, the subscriber management server 560 corresponds to the return information process unit, the set top box 410 corresponds to the return information generation/transmission unit and the program information reception unit.

The two-way communication system according to this embodiment has the above mentioned configuration, and its operation is described below.

According to this embodiment, the data broadcasting company 100 provides a shopping program, an audience participating program in which a set of questions are issued and checked, etc. It is assumed that a subscriber who watches a shopping program places an order which is handled in the program, and answers the questions, etc. Furthermore, according to this embodiment, in addition to the detailed format requested by the data broadcasting company 100 for use in placing an order and answering the questions, a simple format for use by each subscriber in transmitting the data as return information to the CATV center 500 is provided, thereby reducing the laborious operations and time required to input data by each subscriber.

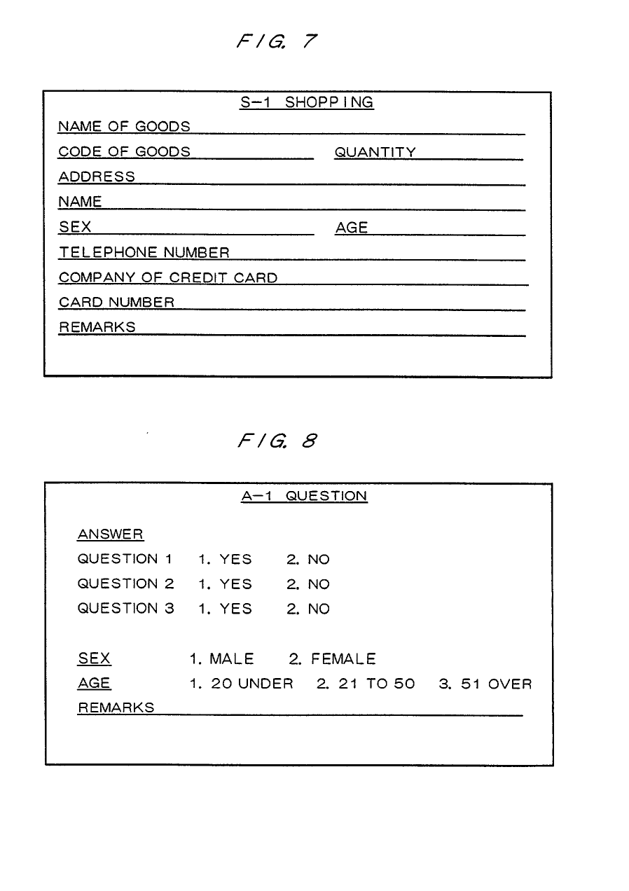

FIGS. 7, 8, and 9 show practical examples of the detailed format requested by the data broadcasting company 100.

FIG. 7 shows the contents of the detailed format used by a subscriber placing an order of any goods handled in a shopping program the subscriber is watching. As shown in FIG. 7, the detailed format S-1 for shopping contains as input items the name of goods, the code of goods, quantity, address, name, sex, age, telephone number, company of credit card, card number, and remarks. Conventionally, all these input items are to be input by a subscriber.

FIG. 8 shows the contents of the detailed format used in answering a set of questions issued in the audience participating program a subscriber is watching. As shown in FIG. 8, the detailed format A-1 for use in answering a set of questions contains selection items (yes and no) corresponding to each of the questions 1, 2, and 3, sex, age, and remarks as input items.

FIG. 9 shows another example of a detailed format for use in answering a set of questions. As shown in FIG. 9, the detailed format A-2 for use in answering a set of questions contains five selection items corresponding to each of the questions 1 to 5, sex, age, occupation and remarks as input items.

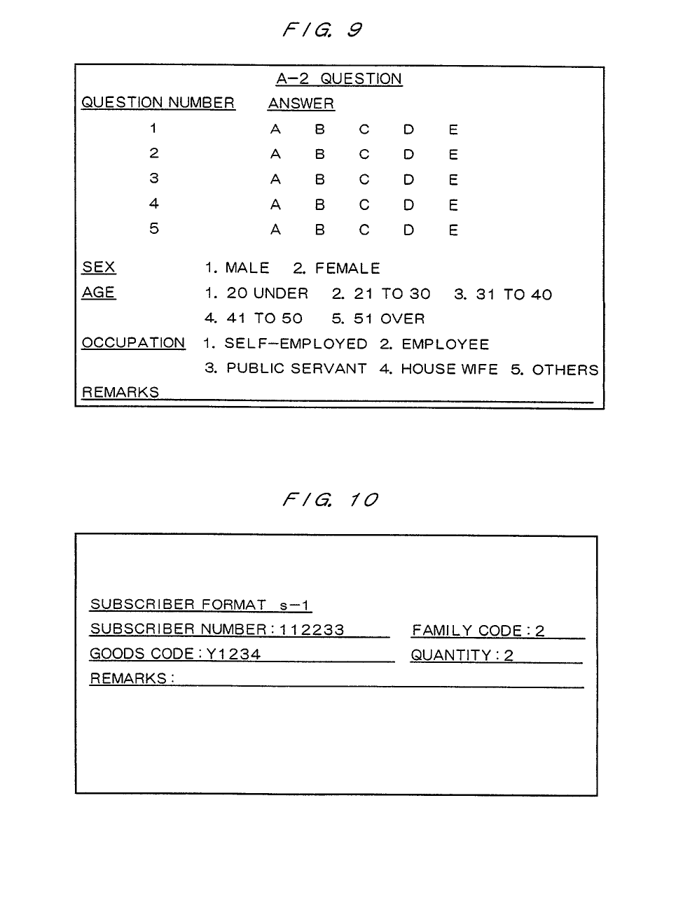

FIGS. 10, 11, and 12 show practical examples of simple formats for use by a subscriber inputting data.

FIG. 10 shows the contents of the simple format used by a subscriber placing an order of any goods handled in a shopping program the subscriber is watching. As shown in FIG. 10, a subscriber number, a family code, a goods code, quantity, remarks are contained as input items corresponding to the subscriber format s-1. The subscriber format s-1 corresponds to the detailed format S-1 shown in FIG. 7. When each subscriber inputs a necessary item using the subscriber format s-1, the contents are transmitted as return information to the CATV center 500, and the subscriber management server 560 in the CATV center 500 converts the information into data according to the detailed format S-1.

FIG. 11 shows the contents of the simple format used in answering a set of questions issued in the audience participating program a subscriber is watching. As shown in FIG. 11, a subscriber number, and an answer are contained as input items corresponding to the subscriber format a-1.

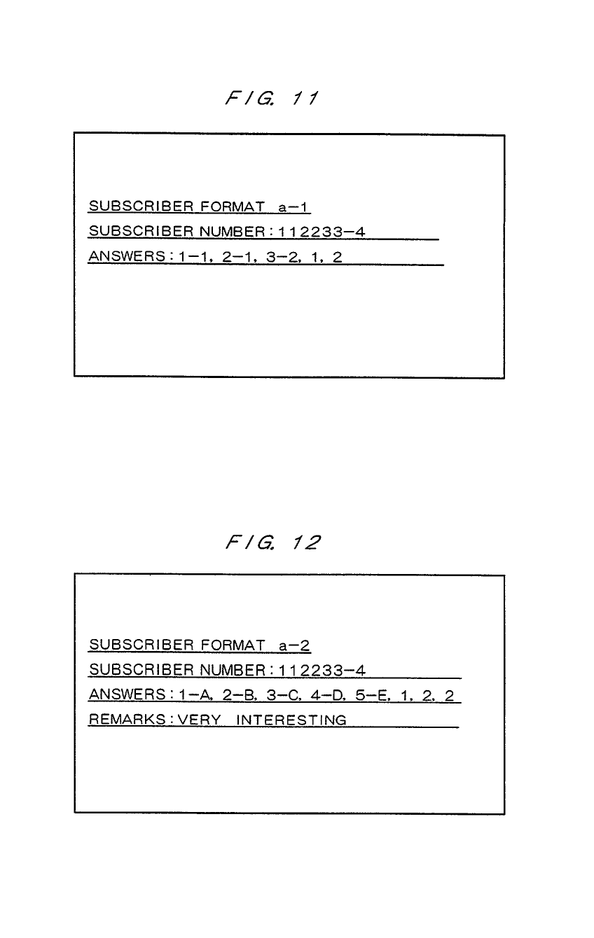

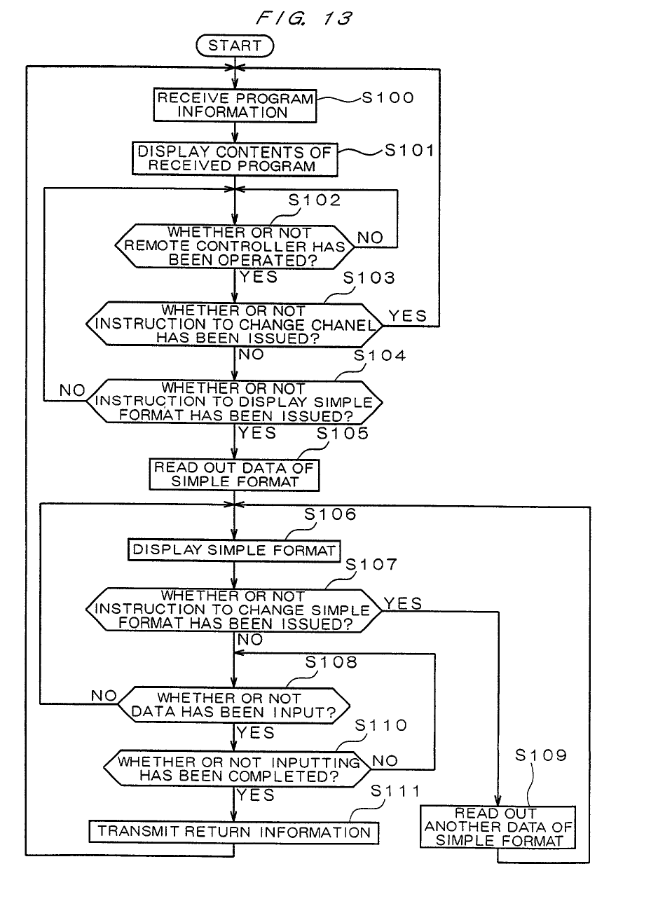

FIG. 12 also shows another example of a simple format for use in answering a set of questions. As shown in FIG. 12, a subscriber number, an answer, and remarks are contained as input items corresponding to the subscriber format a-2.

When the above mentioned two subscriber formats a-1 and a-2 are compared with each other, they are different only in ‘remarks’ as an input item. When the subscriber wants to input any comment in answering the questions, the subscriber selects the subscriber format a-2. Otherwise, the subscriber format a-i is to be selected.

When the detailed formats shown in FIGS. 7 to 9 are compared with the simple formats shown in FIGS. 10 to 12, it is clear that the subscriber does not have to input personal information such as a name, address sex, age, credit card number, etc. when various data is to be input using a simple format. All that the subscriber has to do is to specify the subscriber number instead of inputting the data.

For example, in the example shown in FIG. 10, ‘112233’ is input as a subscriber number, and ‘2’ is input as a family code. The subscriber number is an identification number assigned to each subscriber by a CATV company when each subscriber makes a contract with the CATV company. The subscriber can be specifies by inputting the subscriber number. Therefore, when a subscriber number is input, the subscriber management server 560 in the CATV center 500 refers to the contents of the contract of the subscriber, and can obtain the detailed data such as the address, name, sex, credit card number, etc. In addition, in the example shown in FIG. 10, ‘2’ is input as a family code. A family code is an identification number corresponding to each member of the family. By specifying the family code, the transmitter of the return information can be identified in the family. For example, the family code of ‘2’ refers to the husband or the wife of a subscriber, ‘4’ refers to the first son of the subscriber. As shown in FIG. 11 or 12, the subscriber number can be followed by a - (hyphen) as a delimiter, and then a family code.

FIG. 13 is a flowchart of the procedure of the operations of the set top box 410 when a subscriber inputs return information. The operations of the subscriber inputting the return information using the remote controller 470 are described below by referring to FIG. 13.

When a power supply switch (not shown in the attached drawings) is turned on, the set top box 410 receives a predetermined program information (step S100), and the contents are displayed on the TV 490 (step S101). With the contents of the program information displayed, the CPU 440 determines whether or not the remote controller 470 has been operated (step S102). If the remote controller 470 has not been operated, the determining process is repeated. For simple explanation, it is assumed that the subscriber operates the remote controller 470 to issue an instruction to either change a receiving channel or display a simple format.

If the remote controller 470 has been operated, the determination in step S102 is affirmed, and then the CPU 440 determines whether an instruction to change a receiving channel has been issued (step S103) or an instruction to display a simple format has been issued (step S104). If an instruction to change a receiving channel has been issued, the determination in step S103 is affirmed, control is returned to step S100, and the operation of display the contents of a received program is performed on the new reception channel.

For example, if the contents of a shopping program are displayed on the TV 490, and a subscriber presses a predetermined key of the remote controller 470 to display a simple format at a timing at which an order of goods can be accepted, then an affirmative determination is made in step S104, and the CPU 440 reads any of plural pieces of simple-formatted data stored in the RAM 444 (step S105), and the contents are displayed on the TV 490 (step S106). Assuming that three types of simple-formatted data shown in FIGS. 10 to 12 are stored in the RAM 444, for example, the data corresponding to the subscriber format s-1 shown in FIG. 10 is read from among the stored data, and the contents shown in FIG. 10 are displayed as is on the input screen of the TV 490.

Then, the CPU 440 determines whether or not the remote controller 470 has been operated, and an instruction to change the simple format to be displayed has been issued (step S107), and whether or not data has been input for each input item on the input screen in the simple format being displayed at that time(step S108).

At present, if an audience participating program is displayed on the TV 490, it is necessary to display another simple format shown in FIG. 11 or 12. Therefore, the subscriber presses a predetermined key of the remote controller 470 to change the display of the simple format. In this case, an affirmative determination is made in step S107, and then the CPU 440 first reads data in another simple format from the RAM 444 (step S109), returns to step S106 above described, and repeats the operations of displaying the contents on the TV 490.

When a predetermined key of the remote controller 470 is pressed, and an operation for inputting numerals and characters, etc. in an optional input item of a simple format is performed, an affirmative determination is made in step S108, and then the CPU 440 determines whether or not an inputting operation has been completed (step S110). For example, assuming that a predetermined key of the remote controller 470 is pressed by a subscriber if an inputting operation has been completed, a negative determination is made until the predetermined is pressed, and the determination in step S108 is repeated. If the inputting operation is completed and the predetermined key of the remote controller 470 is pressed, then the CPU 440 transmits return information containing data corresponding to each input item and the type of a simple format (s-1, a-1, etc.) to the CATV center 500 (step S111). The return information can be transmitted through an up line of the CATV network 300 using the QPSK modulator 452 and the tuner 414 as described above.

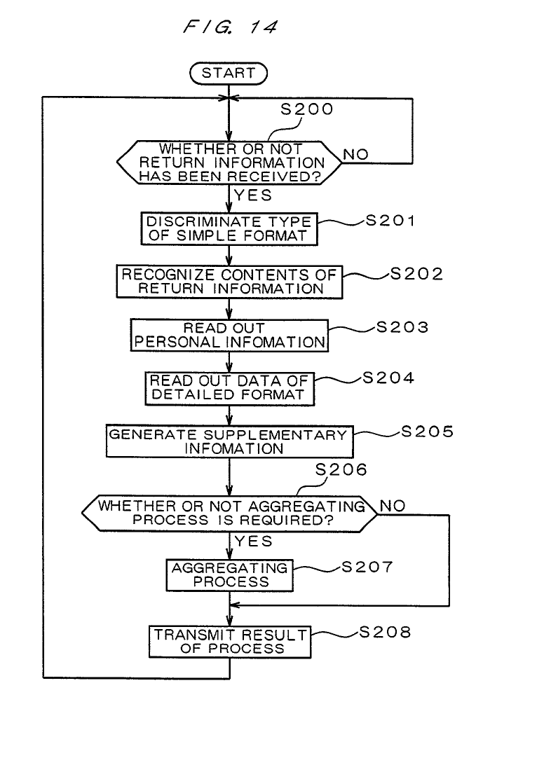

FIG. 14 is a flowchart of the procedure of the operation in the subscriber management server 560 which receives the return information from each subscriber home 400.

The subscriber management server 560 determines whether or not the return information transmitted from any subscriber home 400 through the up line concentration device 540 (step S200). If the information has been received, then it discriminates the type of the simple format (step S201), and recognizes the contents of other return information (step S202). For example, when the return information having the contents shown in FIG. 10 is transmitted, it is determined that the type of the simple format is ‘s-1’, and it is recognized that the subscriber number is 112233, the family code is 2, the goods code is Y1234, the quantity is 2, and no remarks are made.

Then, the subscriber management server 560 reads out the personal information specified by the subscriber number from the database 550 (step S203).

In addition, the subscriber management server 560 reads the data of the detailed format S-1 corresponding to the discriminated simple format s-1 from the database 550 (step S204), and the supplementary information corresponding to each input item in the detailed format S-1 is generated (step S205). For example, the subscriber management server 560 reads the personal information about the subscriber corresponding to the subscriber number 112233 from the database 550, and extracts the address, name, sex, telephone number, credit card company, and card number of the family specified by the family code 2. As for the goods code and the quantity in the input items contained in the detailed format S-1, the data input in the simple format is used as is.

When the process of generating the supplementary information corresponding to the detailed format is completed, the subscriber management server 560 determines whether or not an aggregating process is required (step S206). For example, when a request to aggregate the number of orders for each product in a shopping program, or a request to aggregate the answers to each of the questions in an audience participating program is issued from the data broadcasting company 100 to the subscriber management server 560, an affirmative determination is made in step S206, and the subscriber management server 560 performs a predetermined aggregating process (step S207), and then transmits the result of the above mentioned series of processes to the data broadcasting company 100 through the public network 600 (step S208).

When an aggregating process is not performed, the process is skipped in step S207 after a negative determination is made in step S206, and the result data obtained by the processes of step S200 through step S205 are transmitted to the data broadcasting company 100.

Thus, in the two-way communication system according to this embodiment, each subscriber can input return information in a simple format, thereby considerably reducing a laborious inputting operation and time. Since the subscriber management server 560 in the CATV center 500 performs a process of generating and aggregating supplementary information in response to the return information, the data broadcasting company 100 can obtain information in the conventional detailed format, and also obtain the result of aggregating the contents of the return information transmitted from a plurality of subscribers when an aggregating process is requested. As a result, the operation of performing an aggregating process to be performed in response to the return information directly transmitted from each subscriber can be reduced.

In addition, in the two-way communication system according to this embodiment, a subscriber only has to input data in a simple format and can input data in standardized operations even if a plurality of data broadcasting companies 100 require different detailed formats, thereby improving the operability.

Furthermore, the subscriber makes a predetermined application to a CATV center to use a service according to this embodiment for processing return information so that the subscriber can omit the procedure of registering various items such as names, addresses, etc. in advance for each of the plurality of data broadcasting companies 100, thereby successfully simplifying the entire procedure.

The present invention is not limited to the above mentioned embodiments, and various embodiments can be realized within the scope of the gist of the present invention.

According to the above mentioned embodiments, it is not desired in consideration of the load, etc. in the process of receiving return information that the timings of returning return information from all subscriber homes 400 connected to the CATV network 300 match. Therefore, it is preferable to disperse reception timings. For example, by narrowing the transmission range of return information and reducing the number of subscribers who can simultaneously transmit return information, the reception timings can be dispersed.

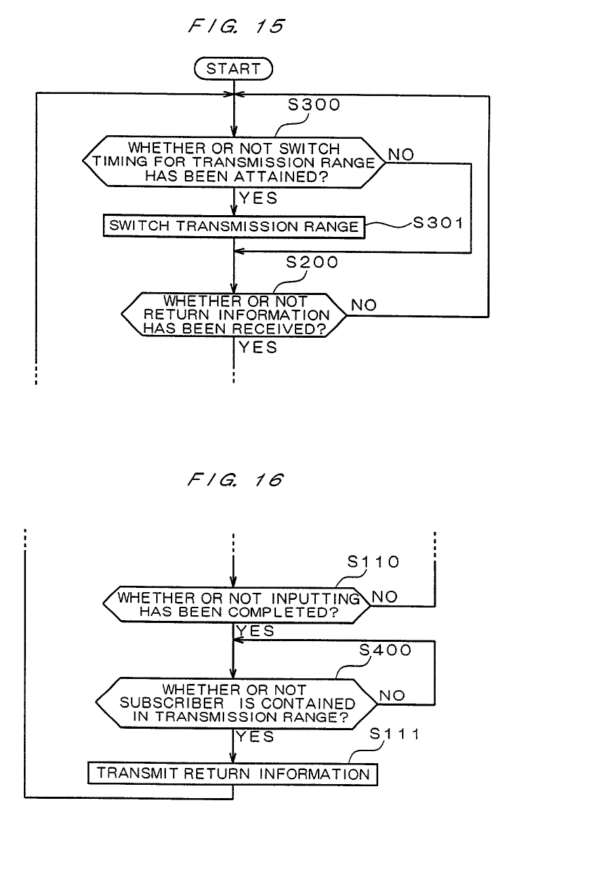

FIG. 15 is a flowchart of the procedure of the operations of the subscriber management server 560 when reception timings are to be dispersed. The procedure of the operations shown in FIG. 15 is different from the procedure of the operations shown in FIG. 14 in that two steps S300 and S301 are added before step S200. Since the processes in and after step S201 are common between the above mentioned procedures, the detailed explanation is omitted in FIG. 15. Practically, the subscriber management server 560 as transmission timing designation unit determines whether or not switch timing for a transmission range has been attained (step S300). If switch timing has been attained, the transmission range is switched (step S301). For example, the digit of the lowest order in the subscriber number is switched at predetermined intervals, and the newly switched value is distributed to each subscriber home 400, thereby switching the transmission range. Hereinafter, the processes in and after step S200 are performed in response to the return information returned from the subscriber home 400 contained in the transmission range.

FIG. 16 is a flowchart of the procedure of the operations of the set top box 410 in each subscriber home 400 when reception timings are dispersed. The procedure of the operations shown in FIG. 16 is different from the procedure of the operations shown in FIG. 13 in that step S400 is added between steps S110 and S111. Since other processes are common between the above mentioned procedures, the detailed explanation is omitted in FIG. 16. Practically, when an affirmative determination is made in step S110 after a subscriber has completed the inputting operation, the CPU 440 determines whether or not the subscriber is contained in the transmission range (step S400), and transmits return information in step S111 only when it is contained in the transmission range. For example, assuming that the value of the lowest order in the subscriber number is distributed to specify the transmission range, it is checked whether or not the distributed value of the lowest order matches the value of the lowest order in the subscriber number of the subscriber having the set top box 410. If yes, an affirmative determination is made in step S400. Thus, by the CATV center 500 specifying the subscriber home 400 from which return information can be simultaneously transmitted, the reception timings of return information can be dispersed.

Other methods can be adopted as a method of dispersing the reception timings of return information. For example, an up path selection device is provided as path switch unit in a CATV network, and the selection status in the device is switched by the CATV center 500.

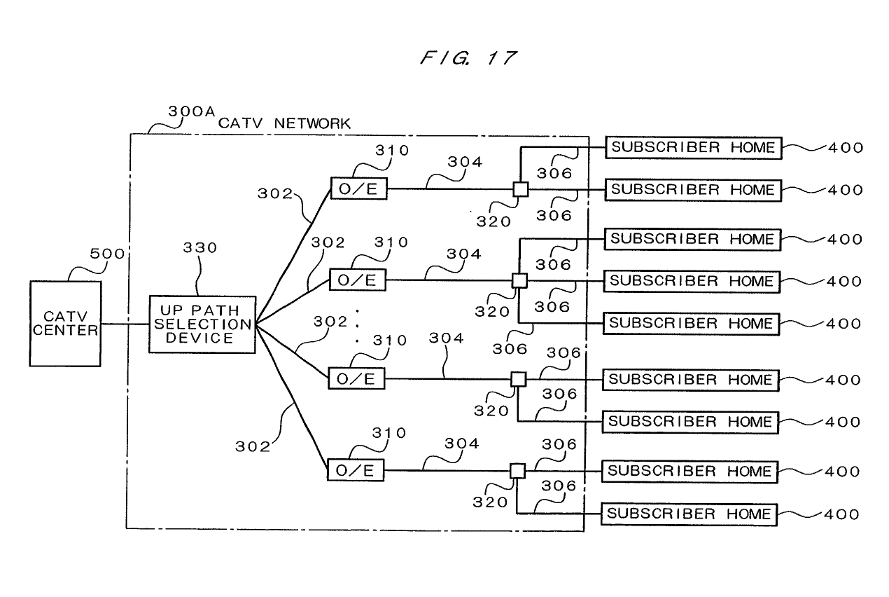

FIG. 17 shows an example of a variation of the connection of the transmission line of a CATV network. The CATV network 300A shown in FIG. 17 comprises an up path selection device 330 between the CATV center 500 and each of the optical-to-electrical (O/E) converters 310. The up path selection device 330 selectively and cyclically activates a plurality of up lines formed by each of the plurality of optical fiber cables 302.

FIG. 18 is a flowchart of the procedure of the operations of the subscriber management server 560 when an up path is selected to disperse reception timings. The procedure of the operations shown in FIG. 18 is different from the procedure of the operations shown in FIG. 14 in that two steps S500 and S501 are added before step S200. Since the processes in and after step S201 are common between the above mentioned procedures, the detailed explanation is omitted in FIG. 18. Practically, the subscriber management server 560 determines whether or not a path switching timing has been attained (step S500). If the switch timing has been attained, a switch instruction is issued to the up path selection device 330 to switch a valid up line (step S501). For example, valid up lines are switched at predetermined intervals. Then, the processes in and after step S200 are performed on the return information returned from the subscriber home 400 connected to the newly valid up line.

In the above mentioned embodiment, the return information returned from each subscriber home 400 is received by the up line concentration device 540, and after the subscriber management server 560 performs a predetermined process on the received return information, the result is transmitted to the data broadcasting company 100. Therefore, a delay occurs by the time taken to perform the process. However, depending on the contents of return information, the data broadcasting company 100 may request to obtain return information with the shortest possible delay time. In such a case, it is desired that the CATV center 500 does not perform a process on the return information transmitted from each subscriber home 400, transmits the information as is to the data broadcasting company 100, and then performs the process.

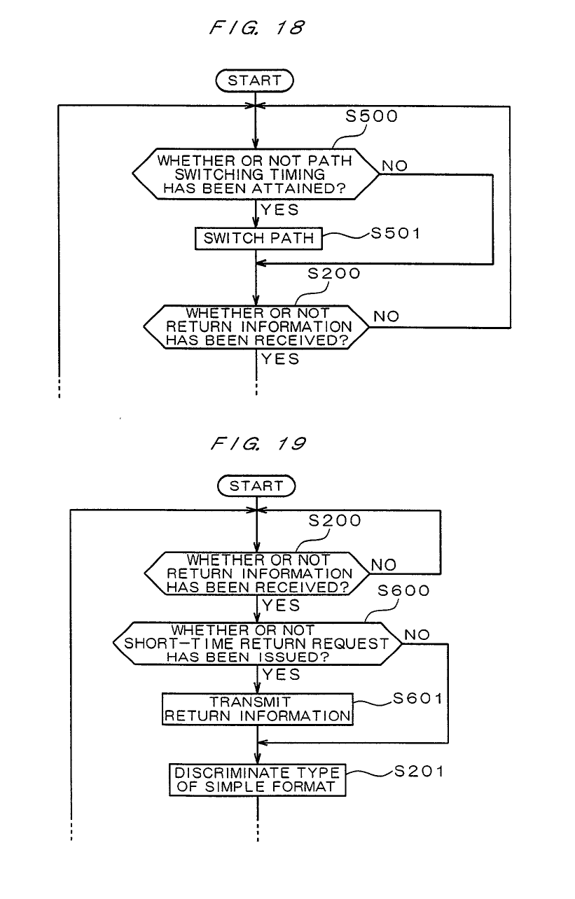

FIG. 19 is a flowchart of the procedure of the operations of the subscriber management server 560 in which received return information can be transmitted within a short time. The procedure of the operations shown in FIG. 19 is different from the procedure of the operations shown in FIG. 14 in that two steps S600 and S601 are added between steps S200 and S201. Since the processes in and after step S201 are common between the above mentioned procedures, the detailed explanation is omitted in FIG. 19. Practically, after the subscriber management server 560 receives the return information transmitted from the subscriber home 400 (after an affirmative determination is made in step S200), it determines whether or not a short-time return request has been issued on the received return information (step S600). If yes, then the return information before performing a predetermined process (original data) is transmitted to the data broadcasting company 100 (step S601). Then, a series of operations in and after step S201 are performed to perform the predetermined process.

In the above mentioned embodiment, the transmission line of the CATV network 300 is used as an up line for transmission of return information from each subscriber home 400 to the CATV center 500, and the return information is transmitted using a cable modem. However, a public telephone line can be used as an up line.

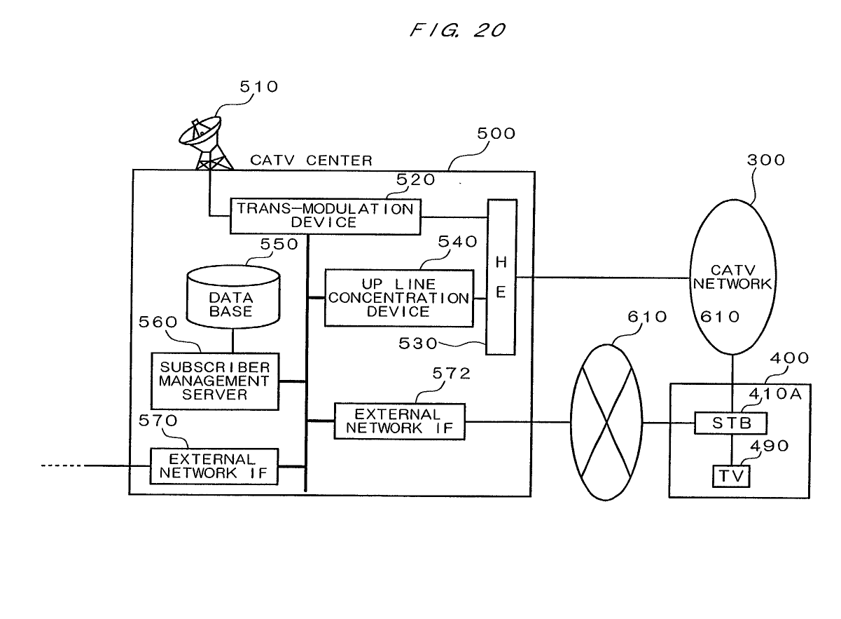

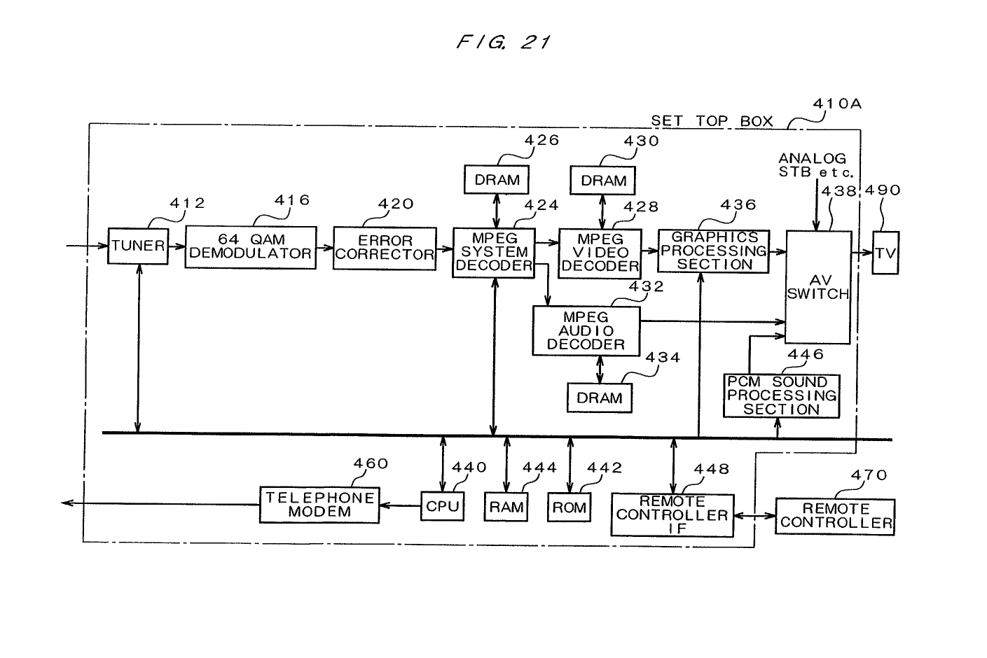

FIG. 20 shows the configuration of the two-way communication system when a public telephone line is used as an up line through which return information is returned. The configuration is different from that shown in FIG. 1 in that the public telephone line set through a public network 610 is used as an up line for transmission of return information. To attain this, an external network interface (IF) 572 is provided in the CATV center 500. In addition, a set top box provided in the subscriber home 400 has to be provided with a telephone modem instead of a cable modem.

FIG. 21 shows the detailed configuration of the set top box 410A containing a telephone modem. The set top box 410A shown in FIG. 21 is different from the set top box 410 shown in FIG. 6 in that a telephone modem 460 replaces each necessary configuration for realization of the function of a cable modem, and that each necessary configuration (the tuner 413, the 64 QAM demodulator 418, the error corrector 422, and the data interface 450) for transmission of received data to a personal computer is omitted. The functions of receiving other contents of programs are common between the above mentioned boxes. The telephone modem 460 controls the transmission of the return information generated by the CPU 440 to the CATV center 500 using a public telephone line set through the public network 610.

Furthermore, according to the above mentioned embodiment, the detailed format requested by the data broadcasting company 100 is described as being stored in the database 550 in advance. However, since there are normally pluralities of data broadcasting companies 100, and the available detailed formats in each data broadcasting company 100 can be appropriately added, it is desired that the CATV center 500 can automatically collect the detailed formats not yet stored in the database 550.

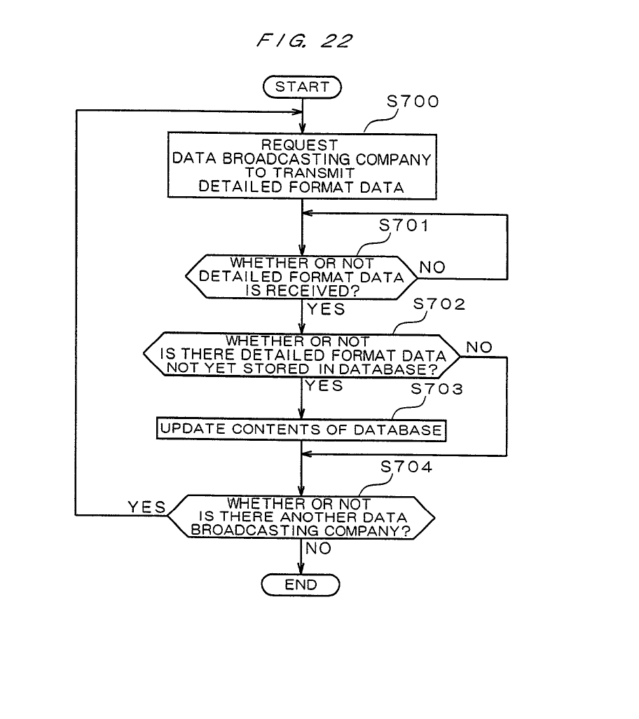

FIG. 22 is a flowchart of the procedure of the operations of the subscriber management server 560 for automatically collecting detailed formats. The subscriber management server 560 as detailed format collection unit requests the data broadcasting company 100 to transmit detailed format data at a predetermined timing (step S700). The transmission request is periodically (for example, once a day) issued.

When the subscriber management server 560 keeps waiting till after issuing a transmission request (step S701). When the subscriber management server 560 receives the detailed format data transmitted from the data broadcasting company 100, it determines whether or not the database 550 contains detailed format data not yet stored in the database 550 (step S702). When the database 550 contains detailed format data not yet stored there, it makes an affirmative determination, and the subscriber management server 560 adds the detailed format data, and updates the contents of the database 550 (step S703). After the contents of the database 550 have been completely updated, or when there are no detailed format data not yet stored in the database 550, a negative determination is made in step S702, and the subscriber management server 560 determines whether or not another data broadcasting company 100 exists (step S704). If it exists, control is returned to step S700, and the process is repeated on the data broadcasting company 100. When the detailed format data has completely been collected for the data broadcasting company 100, a negative determination is made in step S704, and a series of operations are completed. Thus, the detailed format data is automatically collected from the data broadcasting company 100, and the contents of the database 550 are updated.

According to the above mentioned embodiment, program information is retransmitted using a trans-modulation device, but the program information can be retransmitted using transmission system other than the trans-modulation system. For example, the Re-MUX system and a pass-through system can be adopted.

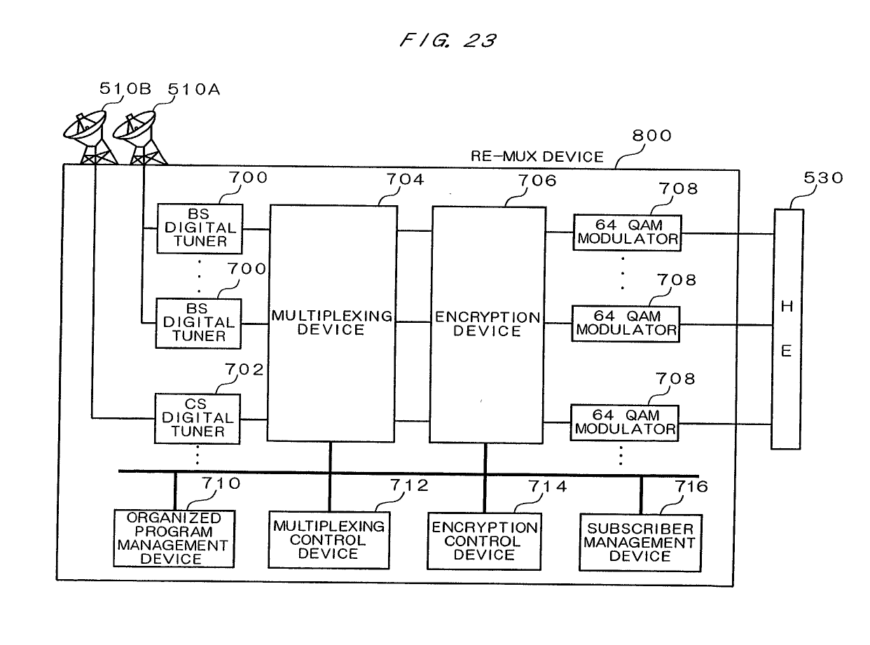

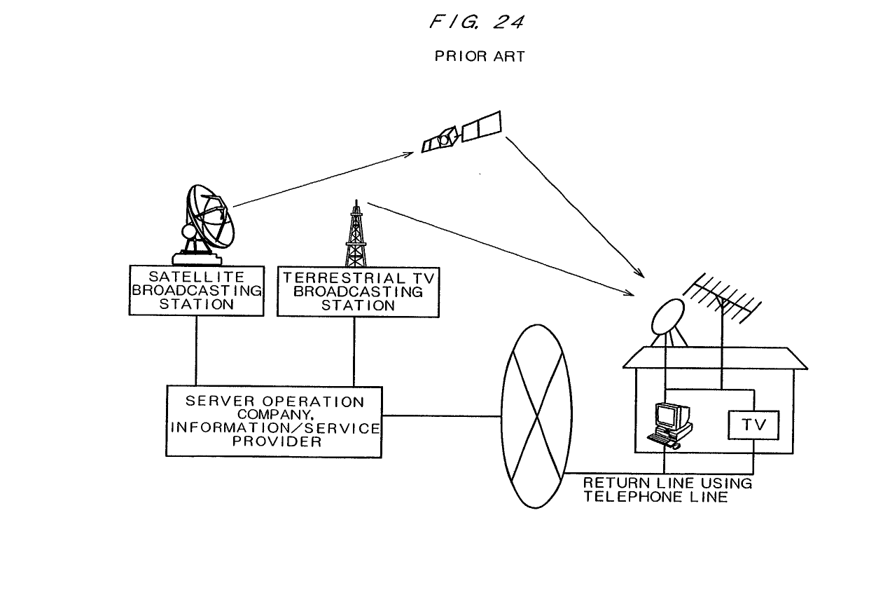

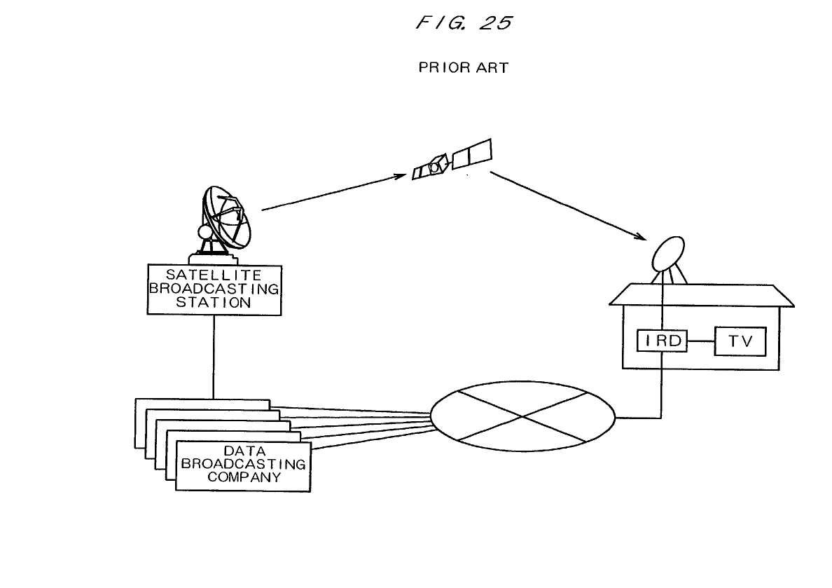

FIG. 23 shows the practical configuration of a Re-MUX device in the Re-MUX system. As shown in FIG. 23, a Re-MUX device 800 comprises a BS digital tuner 700 connected to a BS antenna 510A, a CS digital tuner 702 connected to a CS antenna 510B, a multiplexing device 704, an encryption device 706, a 64 QAM modulator 708, an organized program management device 710, a multiplexing control device 712, an encryption control device 714, and a subscriber management device 716. The organized program management device 710 edits a program by selecting an optional program contained in a BS digital signal and a CS digital signal. The multiplexing control device 712 multiplexes a plurality of programs edited by the organized program management device 710 by controlling the multiplexing device 704. The encryption control device 714 performs a scrambling process on program information. Using the Re-MUX device 800, optional programs contained in the BS digital signal and the CS digital signal can be selectively combined so that the programs can be appropriately edited.

According to the above mentioned embodiment, it is assumed that the data broadcasting company 100 provides a shopping program and an audience participating program in which a set of questions are issued to the audience. However, when the data broadcasting company 100 is a public organization, it can provide a program which is a simulation of operations through windows in the public organization. In this case, the CATV center 500 can be used as a branch office of the public organization, and each subscriber operates the remote controller 470 and inputs in the simple format prepared for an application for a resident registration certificate, etc., thereby applying for a predetermined certificate to a public organization.

1. A two-way communication system which provides program information to be distributed for a CATV subscriber from a program information provider in a predetermined broadcasting system through a CATV network, and returns return information from the CATV subscriber to the program information provider, comprising:
return information reception unit, provided in a CATV center connected to the CATV network, for receiving the return information returned from the CATV subscriber;
return information process unit, provided in the CATV center, for processing the return information received by said return information reception unit, and transmitting the information to the program information provider; and
return information generation/transmission unit, provided in a home of the CATV subscriber, for generating the return information, and transmitting the information to the CATV center.

2. The two-way communication system according to claim 1, wherein
said process performed on the return information by said return information process unit is adding supplementary information to the return information, or replacing the return information with the supplementary information.

3. The two-way communication system according to claim 2, wherein
said CATV center comprises a database storing contract information about the CATV subscriber for use in using the CATV network, and
said return information process unit generates the supplementary information according to personal information contained in contract information about the CATV subscriber stored in the database.

4. The two-way communication system according to claim 2, wherein
said return information process unit converts the return information input by the CATV subscriber in a simple format into the supplementary information in accordance with a detailed format.

5. The two-way communication system according to claim 1, wherein
said process performed on the return information by said return information process unit is performing an aggregating process on the return information returned from a plurality of CATV subscribers.

6. The two-way communication system according to claim 1, wherein
when an answer in a short time is requested, said return information process unit transmits the return information itself to the program information provider.

7. The two-way communication system according to claim 6, wherein
said return information process unit transmits a result of processing the return information after completing transmission of the return information.

8. The two-way communication system according to claim 1, wherein
said program information provider is a public organization, and
said return information is an application for a service to be provided by the public organization.

9. The two-way communication system according to claim 1, wherein
a public telephone line is used as an up line for transmission of the return information from said return information generation/transmission unit to the CATV center.

10. The two-way communication system according to claim 1, wherein
a transmission line contained in the CATV network is used as an up line for transmission of the return information from said return information generation/transmission unit to the CATV center, and said return information is transmitted to the transmission line using a cable modem.

11. The two-way communication system according to claim 10, wherein
an area having a transmission line frequency at or higher than 770 MHz is used as a band of a signal contained in the return information.

12. The two-way communication system according to claim 4, wherein
a home of the CATV subscriber is provided with program information reception unit for receiving the program information, a television set for displaying contents of the program information received by said program information reception unit, and a remote controller having a plurality of operation keys which can be operated with the contents of the program information displayed and viewed on the television set, and
said CATV subscriber inputs the return information by operating the plurality of operation keys provided on the remote controller with an input screen in the simple format displayed on the television set.

13. The two-way communication system according to claim 1, further comprising
transmission timing designation unit for specifying a transmission timing for the return information corresponding to each of the plurality of CATV subscribers, thereby dispersing reception timings of the return information received by said return information reception unit.

14. The two-way communication system according to claim 1, further comprising
path switch unit for selectively activating a plurality of paths through which the return information corresponding to each of the plurality of CATV subscribers is transmitted, thereby dispersing reception timings of the return information received by said return information reception unit.

15. The two-way communication system according to claim 1, wherein
a predetermined additional rate is set corresponding to a service of processing the return information by said return information process unit, and the additional rate is collected from the CATV subscriber who receives the process service.

16. The two-way communication system according to claim 1, wherein
a predetermined additional rate is set corresponding to a service of processing the return information by said return information process unit, and the additional rate is collected from the program information provider who receives the process service.

17. The two-way communication system according to claim 12, wherein
said return information generation/transmission unit has memory storing information about a plurality of simple formats any of which can be selected, and selectively displays contents on an input screen in each of a plurality of simple formats on the television set at an instruction from the CATV subscriber.

18. The two-way communications system according to claim 3, wherein
said personal information contains information about a family configuration of the CATV subscriber,
said return information generation/transmission unit generates the return information containing first identification information specifying the CATV subscriber, and second identification information specifying a member of the family of the CATV subscriber, and
said return information process unit generates the supplementary information according to the first and second identification information contained in the return information.

19. The two-way communication system according to claim 4, wherein
said detailed format is set by the program information provider, and
said system further comprises detailed format collection unit, provided in the CATV center, for automatically fetching the detailed format having contents newly set by the program information provider.
